(19) United States
(12) Patent Application Publication
(10) Pub. No.: US 2011/0258317 A1
(43) Pub. Date: Oct. 20, 2011

(54) APPLICATION SLA BASED DYNAMIC, ELASTIC, AND ADAPTIVE PROVISIONING OF NETWORK CAPACITY

(75) Inventors: Suyash Sinha, Snohomish, WA (US); Sreenivas Addagatla, Redmond, WA (US)

(73) Assignee: Microsoft Corporation, Redmond, WA (US)

(21) Appl. No.: 12/762,372

(22) Filed: Apr. 19, 2010

(51) Int. Cl. G06F 15/173

(52) U.S. Cl. 709/226

(57) ABSTRACT

A network resource management (NRM) system is described for allocating portions of available network capacity to applications, where the available network capacity is treated as a pool of virtual network resources. The NRM system operates by receiving a service level agreement (SLA) that specifies network resources that are requested by an application. The NRM system also receives network topology information regarding features of a physical communication network, which define, in turn, the available network capacity. Based on these inputs, the NRM system allocates a portion of the available network capacity to the application, to produce an SLA assignment. The NRM system then monitors events that may affect the SLA assignment. If such an event is detected, the NRM system can modify the SLA assignment, e.g., by changing or releasing the network resources assigned to the application, etc.

### BACKGROUND

A data center may offer virtual processing resources and virtual memory resources to end-users. These virtual resources map to respective physical processing resources and physical memory resources. In operation, an end-user may specify processing and memory requirements associated with a particular processing task. The data center can then map the requirements into physical allocations of processing and memory resources. In doing so, the mapping performed by the data center is transparent to the end-user. That is, the user is typically unaware of how a processing task is being parsed out to one or more computing machines or the like within the data center.

A data center may include network infrastructure which connects computing machines together. In general, numerous techniques exist to manage traffic in a network infrastructure. However, these techniques are orthogonal to the type of abstract allocations performed by a data center with respect to processing and memory resources. Further, these techniques do not take into consideration the configuration and capacity of the network infrastructure.

### SUMMARY

A network resource management (NRM) system is described that allocates portions of available network capacity to applications to satisfy the communication needs of the applications. The assigned network resources constitute virtual resources which map to physical communication resources (e.g., physical links, etc.) of an underlying physical communication network.

According to one illustrative implementation, the applications that use the network resources correspond to programs for execution by a data center (e.g., in a cloud computing environment or the like). The physical communication network corresponds to the infrastructure which couples computing machines together within the data center. Hence, such a data center can treat all of its processing resources, memory resources, and network resources as virtual resources. The data center can elastically provision all of these resources to meet demands specified by applications.

According to one illustrative implementation, the NRM system can include a service level agreement (SLA) interface module, a network topology interface (NTI) module, and a resource assignment module. The SLA interface module operates by receiving a service level agreement (SLA) that specifies an application's request for network resources. That request can be expressed in high-level form in the context of communication relations among application modules. The NTI module receives network topology information regarding features of the physical communication network. The network topology information defines available network capacity, which, in turn, can be represented as a pool of available virtual network resources. Based on these inputs, the resource assignment module allocates a portion of available network capacity to the application, to provide an SLA assignment.

The NRM system also provides a monitoring module for monitoring events which may affect the allocation of network resources to an SLA. For example, the monitoring module can determine that a particular SLA has been completed or has otherwise been aborted. Or the monitoring module can determine that one or more features of the physical communication network have changed in a manner which affects the SLA. The resource assignment module can respond to these events by modifying the SLA assignment, e.g., by changing the subset of resources assigned to the SLA, or by completely releasing the subset of resources, etc.

The above approach can be manifested in various types of systems, components, methods, computer readable media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a network resource management (NRM) system for allocating available network capacity to applications as virtual resources.

FIG. 2 is a graphical depiction of how physical network resources of a data center can be represented as a pool of virtual network resources for use by applications.

FIG. 3 is an illustrative graphical representation of an application that involves interaction among a plurality of application modules.

FIG. 4 shows an illustrative service level agreement (SLA) that specifies network resources that are requested for the application of FIG. 3.

FIG. 5 shows an illustrative procedure that sets forth one manner of operation of an SLA interface module, for use in the NRM system of FIG. 1.

FIG. 6 shows an illustrative procedure that sets forth one manner of operation of a network topology interface (NTI) module, for use in the NRM system of FIG. 1.

FIGS. 7 and 8 are illustrative procedures that set forth one manner of operation of a resource assignment module, for use in the NRM system of FIG. 1.

FIG. 9 shows a physical communication network that has designated physical resources for satisfying the SLA of FIG. 4.

FIG. 10 is an illustrative procedure that sets forth one manner of operation of a monitoring module, for use in the NRM system of FIG. 1.

FIG. 11 shows illustrative processing functionality that can be used to implement any aspect of the features shown in the foregoing drawings.

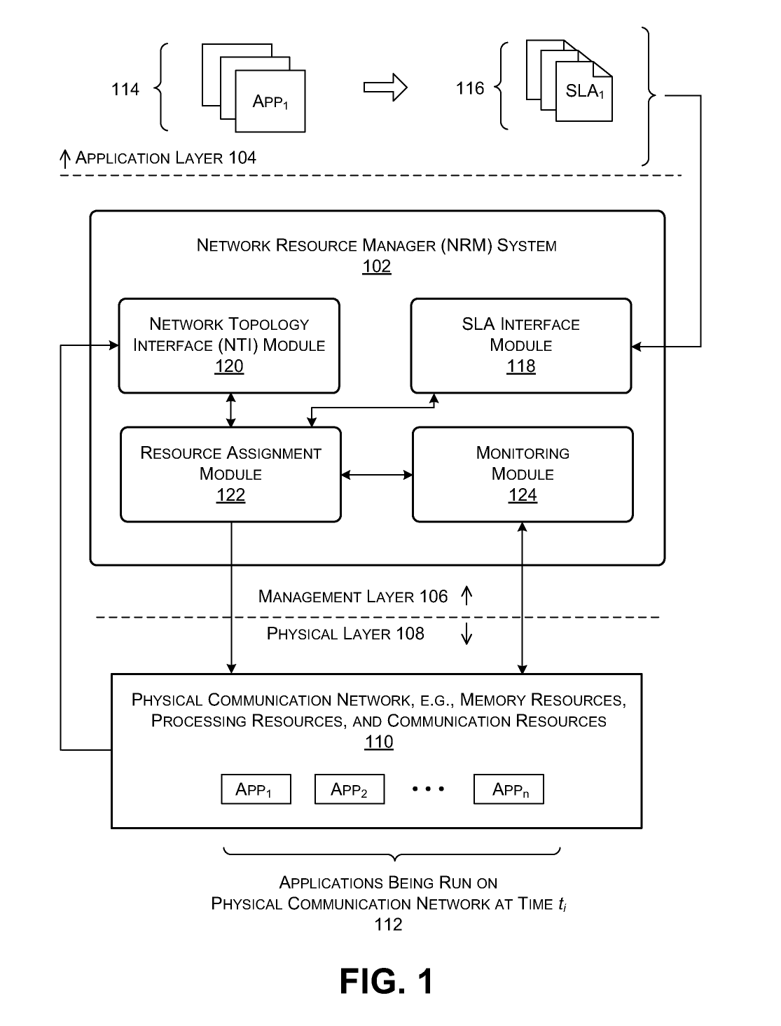

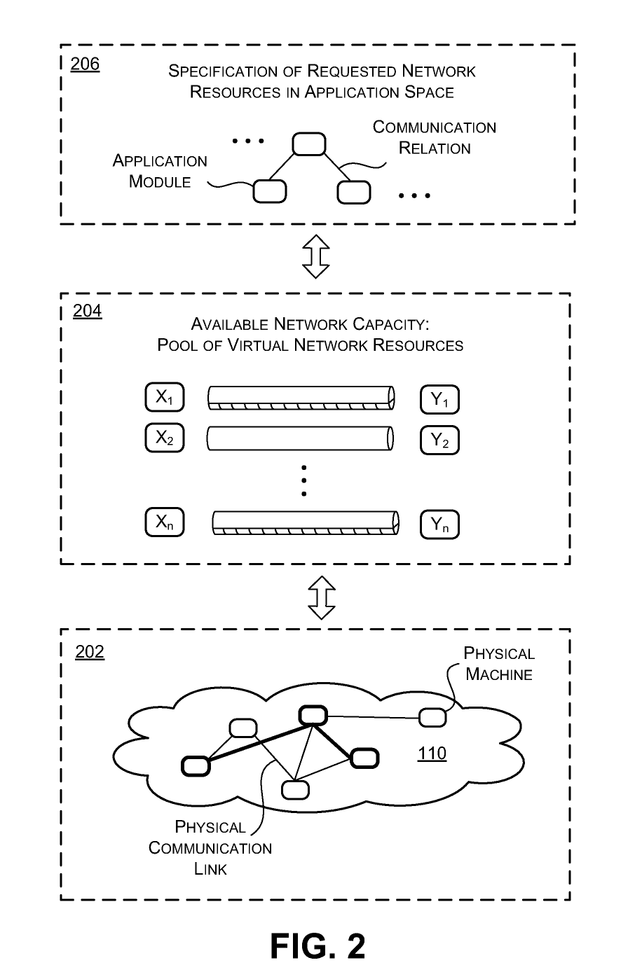

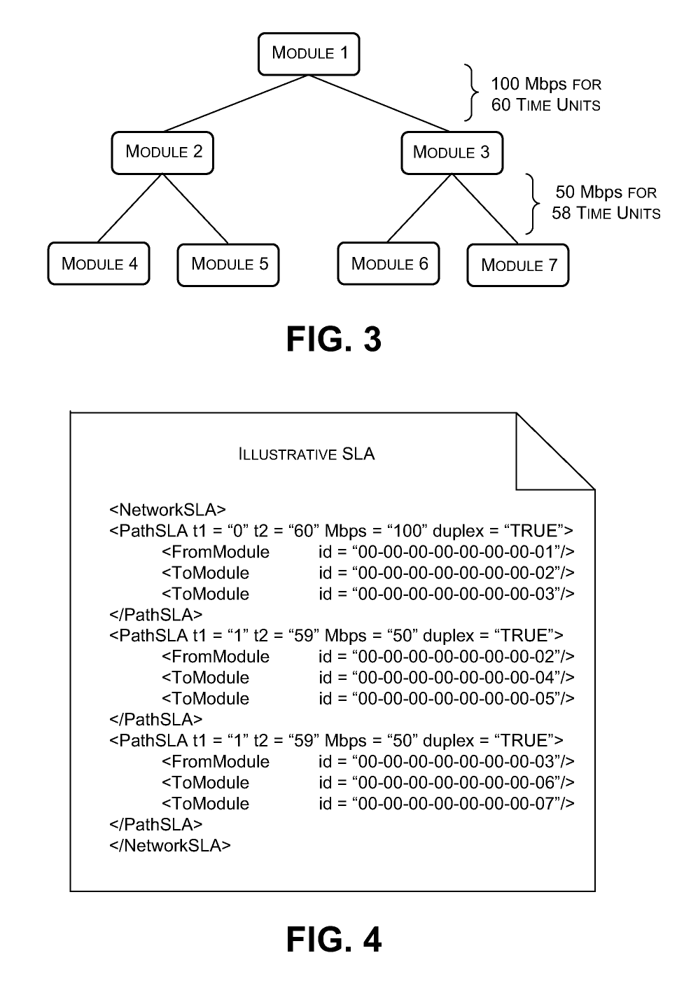

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

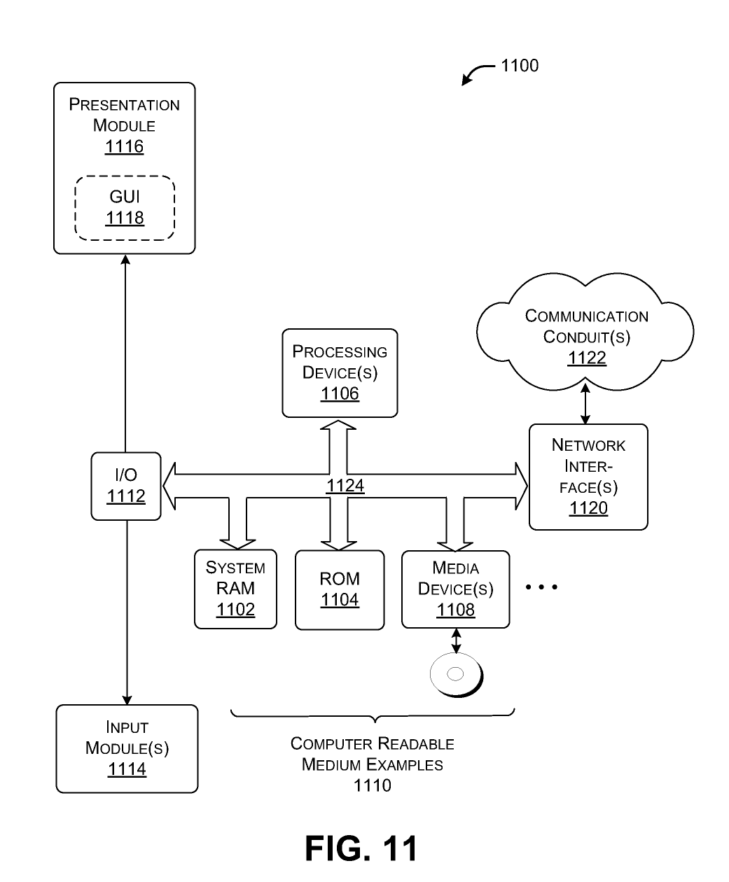

This disclosure describes an illustrative network resource management (NRM) system for allocating portions of available network capacity to applications, thus providing dynamic, elastic, and adaptive provisioning of network capacity. As a preliminary matter, some of the figures describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 11, to be discussed in turn, provides additional details regarding one illustrative implementation of the functions shown in the figures.

Other figures describe the concepts in flowchart form. In this form, certain operations are described as constituting distinct actions performed in a certain order. Such implementations are illustrative and non-limiting. Certain actions described herein can be grouped together and performed in a single operation, certain actions can be broken apart into plural component actions, and certain actions can be performed in an order that differs from that which is illustrated herein (including a parallel manner of performing the actions). The actions shown in the flowcharts can be implemented in any manner.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

FIG. 1 shows an illustrative network resource management (NRM) system 102 for allocating portions of available network capacity to applications. For example, the NRM system 102 can be used to manage the allocation of network resources in a data center or the like. For example, the data center may correspond to a cloud computing service that provides a computing service to an end-user. The end-user can use the service by submitting an application to the data center. In one case, the end-user may be located at a remote site with respect to the service; here, the end-user can supply the application via a network (e.g., a wide area network, a local area network, or combination thereof). In another case, the end-user may be located at the same site as the service; here, the user can manually feed the application to the service. Upon receipt, the data center executes the operations specified by the application and provides a result to the end-user. Alternatively, or in addition, the service can store information supplied by the end-user.

The NRM system 102 operates in an environment that can be conceptualized as having three layers or levels: an application layer 104; a resource management layer 106; and a physical layer 108. Starting from the bottom of the figure, the physical layer 108 includes a physical communication network 110. For example, in a data center environment, the physical communication network 110 may correspond to an actual collection of physical computing machines (e.g., servers) and data stores for performing any type of processing task, as specified by the applications supplied by end-users. A collection of physical links (and optionally, routers, etc.) connect the machines together. Collectively, the machines, links, routers, etc. form a network infrastructure that comprises the physical communication network 110. At any given time tᵢ, the physical communication network 110 may be executing a collection of applications 112.

The management layer 106 treats the physical resources of the physical communication network 110 as virtual resources. More specifically, the physical communication network 110 has a number of physical features which collectively contribute to an available network capacity. The management layer 106 treats the available network capacity as a pool of available virtual network resources. In general, the NRM system 102 operates by mapping portions of the available network capacity to individual applications. In doing so, the NRM system 102 maps the communication needs of the applications to the underlying physical resources of the physical communication network 110. However, this mapping can be performed in a manner that is transparent to the end-user.

The application layer 104 enables the end-users to express communication needs of applications 114 using respective service level agreements (SLAs) 116. That is, each SLA can describe its requested network resources in a high-level form in the context of a plurality of application modules and associated communication relations. The communication relations refer to paths that conduct communication among the application modules. The NRM system 102 receives such an SLA and, as stated, maps the requested network resources to actual physical resources of the physical communication network.

Considered as a whole, the NRM system 102 allows a data center to manage all of its resources as virtual resources. That his, the data center can represent its various resources as a collection of virtual processing resources, virtual memory resources, and virtual network resources that can be elastically provisioned to meet the demands of applications. The ensuing description will focus on the allocation of virtual network resources to meet the communication needs of applications. However, the NRM system 102 can be integrated with a more encompassing management system which, in addition to assigning network resources, assigns processing and memory resources to applications (and/or any other type of resource that is appropriate to carry out an SLA).

Advancing to FIG. 2, this figure summarizes the same concepts described above in another way. At the lowest level, a data center environment includes a physical space or domain 202. The physical space encompasses the physical resources of the physical communication network 110. As stated, the physical resources may include a collection of machines and associated communication links. Although not shown, the physical resources can include other equipment, such as data stores, routers, etc.

A virtual space 204 represents available network capacity of the physical communication network 110 in abstract form as a pool of virtual resources. For example, the pool of virtual resources can be conceptualized as a collection of virtual “conduits” that connect respective source nodes (Xᵢ) to respective destination nodes (Yᵢ). These conduits may correlate to respective physical links in the physical communication network 110. Each individual conduit can be metaphorically thought of as communication pipe that can accommodate a certain amount (and type) of information flow between its respective source node and destination node. Accordingly, in performing its allocation function, the NRM system 102 can choose individual conduits that can support the communication needs of an application, as specified by the application's SLA. When a virtual resource (e.g., a conduit) is reserved for an application, it may still have enough free capacity to handle the communication needs of one or more other SLAs; in other cases, it may not. When an SLA terminates (for any reason), the NRM system 102 can release the virtual resources used by that SLA. This frees the NRM system 102 to assign those virtual resources to other SLAs, such as newly received SLAs.

An application space 206 represents the communication needs of applications as respective SLAs. Each SLA, in turn, can express its communication needs in the context of application modules and communication relations. As will be described below, the application modules refer to components of the application logic that perform different respective functions. The communication relations express respective flows of information between the application modules. An SLA can express its communication needs in the context of a collection of communication requests. Each communication request describes the communication needs of an individual communication relation.

Returning now to FIG. 1, this figure shows that the NRM system 100 can include (or can be conceptualized to include) a collection of modules which allow it to manage network resources. The modules include a service level agreement (SLA) interface module 118, a network topology interface (NTI) module 120, a resource assignment module 122, and a monitoring module 124.

The SLA interface module 118 receives a service level agreement (SLA) from an application. The SLA specifies network resources that are requested by the application, to define requested network resources. Further details regarding SLAs and the SLA interface module 118 are provided below. At this point, suffice it to say the SLA interface module 118 may transform the information in the SLA into a form that is understandable by the resource assignment module 122.

The NTI module 120 receives network topology information. The network topology information identifies features of the physical communication network 110 provided by the data center. Based thereon, the NTI module 120 can represent available network capacity for use by plural applications as a pool of virtual resources. In other words, the NTI module 120 can abstract the physical resources of the physical communication network 110 into the type of abstract conduits illustrated in FIG. 2.

The resource assignment module 122 allocates, if deemed feasible, a portion of the available network capacity to an application based on the SLA and the network topology information. The outcome of this operation is an SLA assignment for the application. Additional details regarding the operation of the resource assignment module 122 will be provided below.

The monitoring module 124 monitors events pertaining to the execution of the application within the data center. Some events originate from issues pertaining to the application itself For example, a first event may correspond to the start of the execution of the application. A second event may correspond to the normal termination of the execution of the application. A third event may correspond to any type of abnormal termination of the execution of the application. For example, an end-user or some other agent may expressly abort an application; or an application may abort due to “bugs” or other anomalies encountered in the execution of the application. Other events may be primarily attributed to what is happening in the physical communication network 110. For example, a fourth event may correspond to a link failure or other anomaly in the physical communication network 110 that affects the execution of the application. The monitoring module 124 can detect and report yet other types of events.

In operation, the monitoring module 124 can pool the links of the physical communication network 110 that are being used to implement a particular SLA. This enables the monitoring module 124 to monitor the state of traffic along those links. The monitoring module 124 can also monitor the network state as a whole.

The resource assignment module 122 receives the events provided by the monitoring module 124. The resource assignment module 122 then determines, for each application that is being executed, whether each event warrants a modification of the resources assigned to the application. For example, if the resource assignment module 122 determines that the application has normally or abnormally terminated, the resource assignment module 122 can release the network resources assigned to the application. This frees the resources to be used for other applications. Or assume that the resource assignment module 122 determines that a link has failed. The resource assignment module 122 can attempt to find another link that can be used to satisfy the application's SLA. In doing so, it produces a new (e.g., updated) SLA assignment.

With the above introduction, additional details will be set forth regarding the operation of individual features of the NRM system 102, with reference to FIGS. 3-10. Starting with FIG. 3, this figure shows a graphical depiction of application modules associated with an application. More specifically, the application may invoke separable processes for execution by different processing agents. The processing agents can correspond to logic that will be provided by different respective computing machines. Alternatively, or in addition, the different processing agents can correspond to different processing threads (or the like) which operate on a single computing machine. In any case, FIG. 3 represents these different processing agents as different application modules. In the merely representative example of FIG. 3, there are seven application modules, labeled 1 through 7.

Communication relations connect the application modules together. For example, a communication relation couples module 1 to module 2. Another communication relation couples module 2 with module 4. Another communication relation couples module 2 with module 5, and so on. As stated, a communication relation refers to a path of information flow between two application modules. The communication path can have various characteristics. For example, a first communication path may be duplex, meaning that it carries information in both directions between the two application modules. A second communication may be simplex, meaning that it carries information in a single direction between the two modules.

Consider the following example in which the application uses the MapReduce framework provided by Google Inc. of Mountain View, Calif. This framework performs a computation using a collection of nodes. A master node first partitions input data into parts. It then sends the parts to subordinate (“worker”) nodes. Any worker node, in turn, may further partition its allocation of data into smaller parts and send those parts to its subordinate nodes. The subordinate nodes process their allocation of data and send results up through the hierarchy of nodes to the master node. The master node processes the partial results to provide a final outcome.

This framework defines a number of application modules corresponding to respective nodes. The framework also defines a collection of communication relations corresponding to the communication paths which connect the nodes together. This is merely one example of a program that leverages the processing capabilities of plural agents.

FIG. 4 shows one illustrative SLA for the application depicted in FIG. 3. Generally, the SLA describes the application modules of the application and the communication relations among the application modules. The SLA can express this information in any form, such as a textual form, a graphical form, or combination thereof For example, the SLA can express these characteristics in XML (Extensible Machine Language) format, CSV (Command Separated Values) format, etc. Alternatively, or in addition, the SLA can express the features by graphically depicting the features in a manner that resembles the diagram shown in FIG. 3, e.g., in graph form. For example, the SLA can be formulated as a Microsoft Office Visio® document, provided by Microsoft Corporation of Redmond, Washington. The SLA can be provided by any type of file.

In general, the SLA can convey different fields of information. First, the SLA can identify the communication relations implicated by a particular application. It can do this by identifying the respective source and destination nodes associated with the communication relations. For example, FIG. 4 uses the tags “FromModule” and “ToModule” to identify different communication relations.

Second, the SLA describes the communication requirements of the identified communication relations. The SLA can convey this information by enumerating communication requests for each respective communication relation. Each communication request, in turn, can include a number of components or features. For example, one component specifies an amount of bandwidth that is requested for the communication relation. A second component specifies at least one timing constraint that pertains to use of the communication relation. A third component specifies a type of communication handled by the communication relation, and so on.

For example, consider the first block of information in the SLA of FIG. 4. This block identifies two communication relations. A first communication relation is defined between module 1 and module 2. A second communication relation is defined between node 1 and node 3. Here, the SLA identifies the nodes by associated ID values; however, other implementations can use other ways to identify the nodes, such as by providing addresses or any type.

The SLA specifies that the two communication relations (between modules 1 and 2, and between modules 1 and 3) are requested to each have a bandwidth of 60 Mbs. Although not shown, the SLA can also define how this value is to be interpreted by the resource assignment module 122. In one case, such a value can refer to a minimum guarantee. In another case, such a value can refer to an average level of service, and so on. The resource assignment module 122 can alternatively interpret values in the SLA based on default rules, which an administrator can set up in any manner. The SLA also specifies that the two communication relations are requested to be bi-directional (duplex). The SLA also specifies that the two communication relations are requested to deliver the desired communication service between times t₁=0 to time t₂=60. The units here can be assigned any value (e.g., seconds, minutes, etc.), as specified by a default rule.

The information imparted by the SLA is depicted and described by way of illustration, not limitation. Other SLAs can describe constraints placed on communication relations in other ways. For example, another SLA (not shown) can express the time period (and/or bandwidth) that is requested in conditional or relative terms (or other high-level or abstract terms). For example, this SLA can specify that a communication path is requested for 50 time units after a certain event X happens (such as the termination of an identified process), or that a communication path is requested until a certain event Y happens or condition Z is present (or absent), etc. Other SLAs can specify a desired reliability of communication relations, a desired Quality of Service (QoS) performance of communication relations, a desired security level of communication relations, a desired latency-related performance of communication relations, and so forth. These examples as representative, rather than exhaustive.

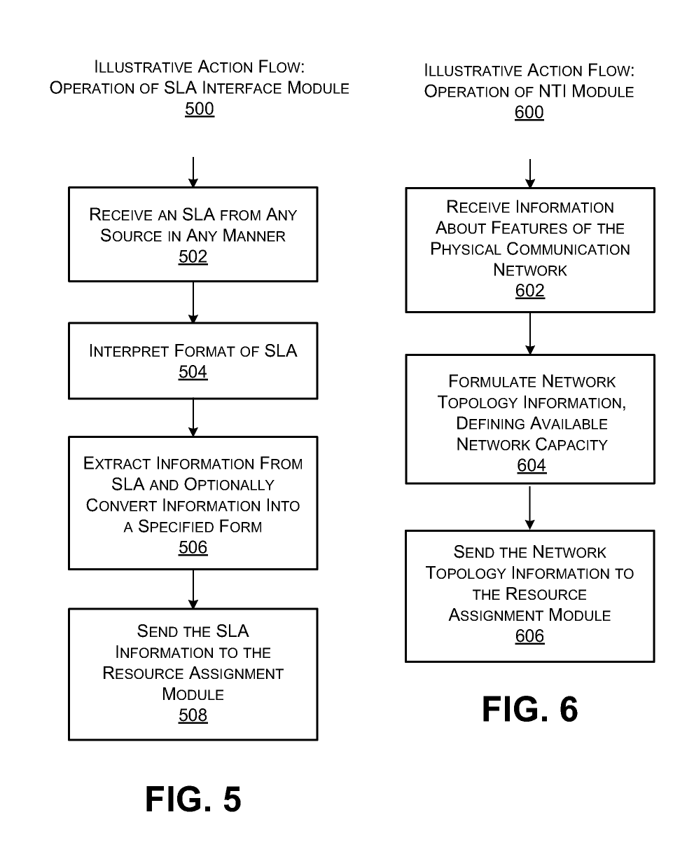

FIG. 5 shows a procedure 500 which describes one manner of operation of the SLA interface module 118. In action 502, the SLA interface module 118 can receive an SLA from any source and in any manner. For example, the SLA interface module 118 can receive an SLA from an end-user over any type of network, such as the Internet.

In action 504, the SLA interface module 118 can optionally analyze the SLA to determine what format it uses to express communication requests. In action 506, the SLA interface module 118 extracts information from the SLA. Optionally, the SLA interface module 118 can also convert the extracted information into a uniform format for processing by the resource assignment module 122. In action 508, the SLA interface module 118 sends the processed SLA information to the resource assignment module 122.

FIG. 6 shows a procedure 600 which describes one manner of operation of the NTI module 120. In action 602, the NTI module 120 can receive information about the physical features of the physical communication network 110. For example, the NTI module 120 can use either a pull or push technique (or combination thereof) to investigate the types of links in the physical communication network 110 and the characteristics of these links.

In action, 604, the NTI module 120 formulates the information that it collects from the physical communication network 110 into network topology information. The network topology information represents the characteristics of the physical communication network 110 in a format that can be interpreted by the resource assignment module 122. In one case, the NTI module 120 can express the resources as a pool of abstract virtual resources (as shown in FIG. 2). The NTI module 120 can also provide a map which links the abstraction formulation of the resources with the corresponding underlying physical resources. (Alternatively, another module, such as the resource assignment module 122, can perform some or all of this abstraction analysis). In action 606, the NTI module 120 sends the network topology information to the resource assignment module 122.

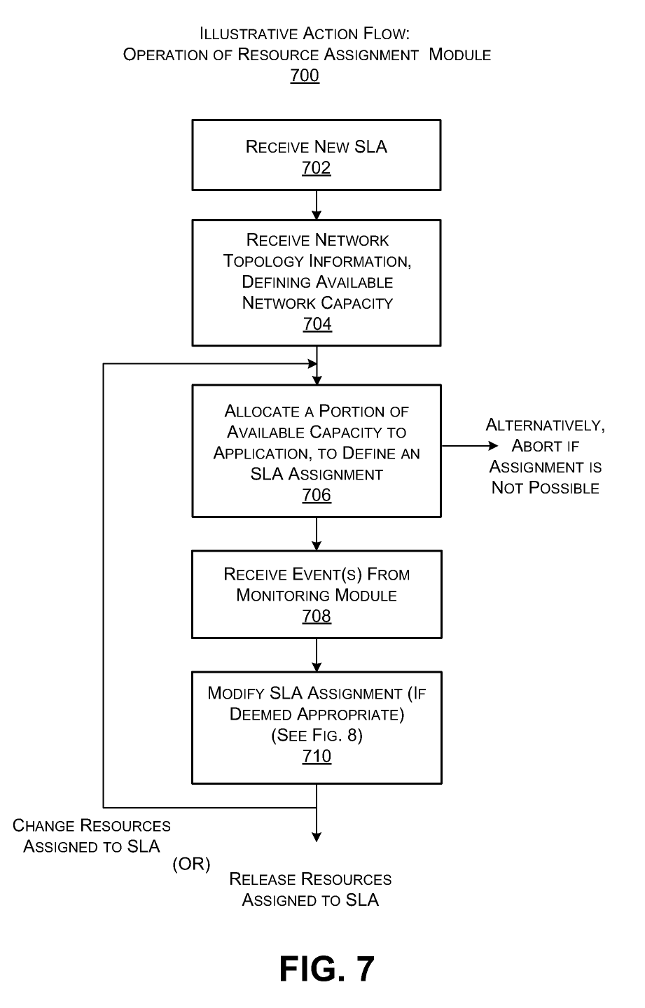

FIG. 7 shows a procedure 700 which describes one manner of operation of the resource assignment module 122, performed with respect to an individual SLA and associated application.

In action 702, the resource assignment module 122 receives a new SLA from the SLA interface module 118. In action 704, the resource assignment module 122 can receive the network topology information from the NTI module 120. The resource assignment module 122 can use any technique to receive the SLA information and the network topology information, such as a pull technique, a push technique, or combination thereof In one case, action 704 can also involve processing the network topology information to formulate this information in an abstract virtual form that can be interpreted by the resource assignment module (that is, if this task has not already been performed by the NTI module 120).

In action 706, the resource assignment module 122 assigns virtual resources to the application based on the application's SLA and the network topology information. Generally, the resource assignment module 122 performs this task by matching up the per-relation communication requests in the SLA with available resources in the pool of virtual resources. For example, assume that the resource assignment module 122 is attempting to find a resource to satisfy a communication request that asks for R amount of bandwidth between two application modules. The network topology information may indicate that a conduit exists between modules X and Y having a total bandwidth of Z. Assume that the resource assignment module 122 concludes that, out of the Z amount of bandwidth, L amount of bandwidth is currently free for use. If the requested amount of bandwidth (R) is less than L, then the resource assignment module 122 can assign a portion of that virtual resource to the communication relation in the SLA. The resource assignment module 122 then updates its information regarding this virtual resource to indicate that this resource now has L-R amount of bandwidth to offer to other applications. The resource assignment module 122 performs this type of analysis with respect to all of the communication requests specified in an SLA.

In some cases, the resource assignment module 122 attempts to find resources that are immediately available for use by the application. Alternatively, or in addition, the resource assignment module 122 can attempt to reserve resources for use starting at respective future specified times. The SLA specifies the time period for which it is requesting resources.

Although not shown, the resource assignment module 122 also takes into consideration other specified requirements of the application. For example, the SLA can also specify that application modules are requested to provide a certain amount of processing capacity and/or memory capacity. The resource assignment module 122 (or some other assignment module that works in cooperation with the resource assignment module 122) can take this information into account when assigning resources to the application. That is, in addition to considering the capacity of a link, the resource assignment module 122 can consider the capabilities of the source and destination nodes associated with the link.

The resource assignment module 122 ultimately uses some mechanism to carry out its assignments within the physical communication network 110. The resource assignment module 122 can rely on different techniques to perform this operation. In one case, the resource assignment module can carry out the assignments by creating virtual circuits in a direct routing network. A direct routing network includes a plurality of computing machines (e.g., servers) coupled directly together over multiple paths. The computing machines include switching functionality which implements the routing within the direct routing network. (A virtual circuit refers to a connection between two computing machines that is managed to behave, in some respects, like a physical connection, even though it is not.) In this case, the NRM 102 can dynamically perform on-demand path set up based on the requests specified in an application's SLA.

In another case, the resource assignment module 122 can carry out the assignments by allocating Differentiated Services (DiffServ) labels in a traditional Internet Protocol (IP) network with explicit routing elements (e.g., router devices). (A Differentiated Services architecture provides a mechanism for providing different levels of service to different types of traffic within a network.) In this case, the NRM 102 can dynamically set up DiffServ mappings on the routing elements according to the requests specified in an application's SLA.

In another case, the resource assignment module 122 can carry out the assignments using physical circuits.

Generally, these examples are representative, rather than exhaustive. The resource assignment module 122 may adopt a mechanism that depends, in part, on the physical characteristics of the physical communication network 110 and the protocols used by the physical communication network 110.

In action 708, the resource assignment module 122 receives events from the monitoring module 124. These events pertain to occurrences that have a bearing on the execution of the application by the physical communication network 110. As described above, these events can be characterized as application-related events and/or network-related events. An application-related event is an event which is primarily attributed to the application. A network-related event is an event which is primarily attributed to the physical communication network 110 on which the application executes.

If action 710, the resource assignment module 122 takes action in response to the received events. More specifically, the resource assignment module 122 can determine whether an event affects any of its pending SLAs (and associated applications). If so, the resource assignment module 122 can perform reallocation by modifying the assignment of resources for this SLA.

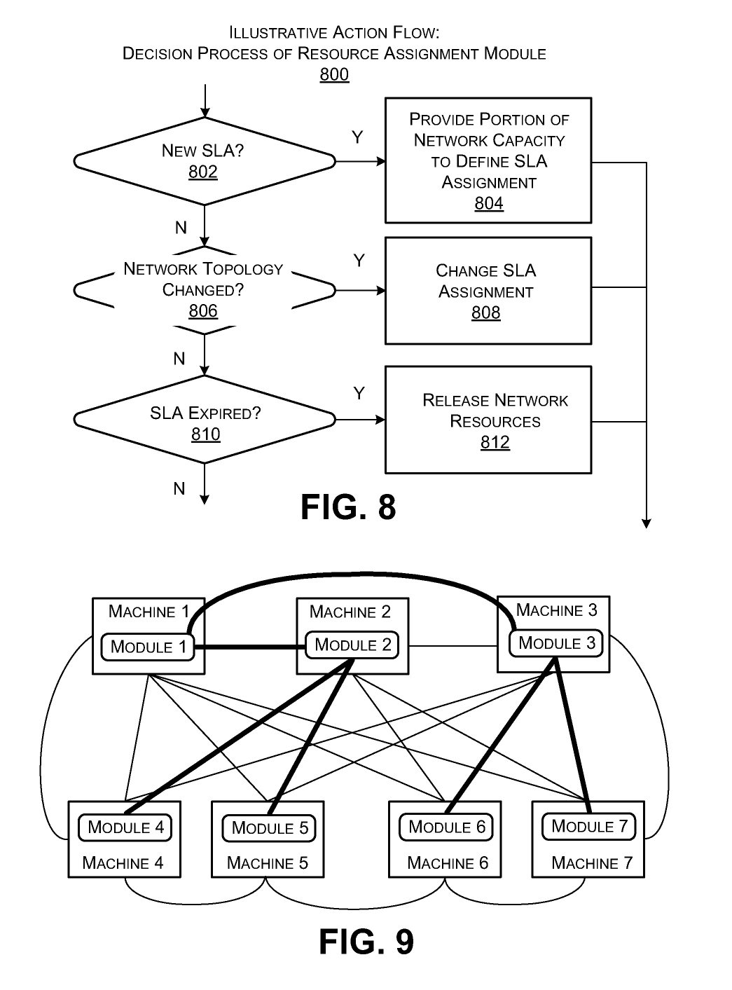

FIG. 8 shows a procedure 800 which elaborates on actions 706, 708, and 710 of FIG. 7. Namely, in action 802, the resource assignment module 122 determines whether a new SLA has been received from the SLA interface module 118. If so, in action 804, the resource assignment module 122 provides a portion of the available network capacity to the SLA in the manner described above.

In action 806, the resource assignment module 122 determines whether an event received from the monitoring module 124 indicates that the network topology (of the physical communication network 110) has changed. If so, in action 808, the resource assignment module 122 may change the SLA assignment(s) that are affected by this change. As described above, this operation may correspond to substituting a previous link assignment (corresponding to a now-failed link) with a new link assignment.

In action 810, the resource assignment module 122 determines whether an event received from the monitoring module 124 indicates that an SLA has expired. An SLA may be deemed to expire if it normally terminates (because it has completed), or if it has been aborted for any number of reasons. If the SLA has expired, in action 812, the resource assignment module 122 can release the resources previously assigned to this SLA.

FIG. 9 shows a particular physical communication network that includes seven computing machines connected in various ways to define a multipath network. Here, the resource assignment module 122 has decided to use machines 1 through 7 to implement, respectively, application modules 1-7 of FIGS. 3 and 4. Further, the resource assignment module 122 has assigned the bolded communication links to implement the communication requests between the application modules. Although not shown, other SLAs and corresponding application may share the use of the bolded links with the SLA described in FIG. 4.

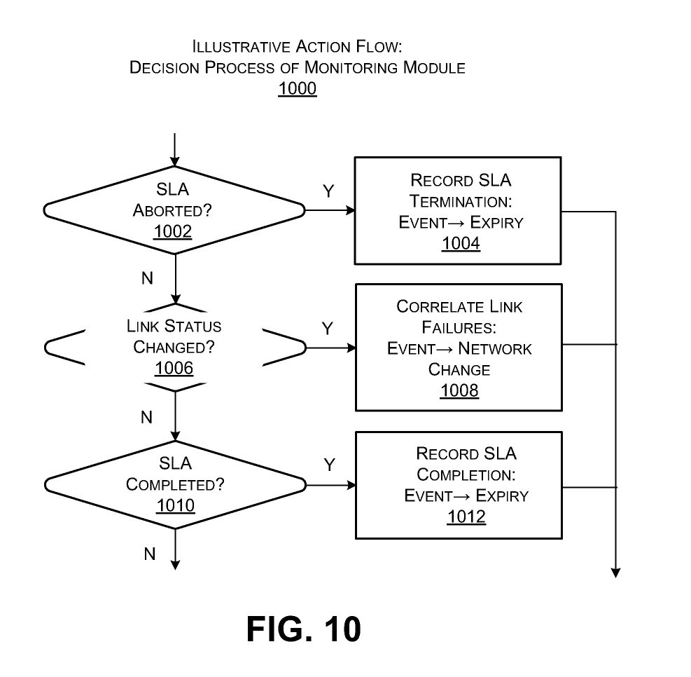

FIG. 10 shows a procedure 1000 which explains one manner of operation of the monitoring module 124. In action 1002, the monitoring module 124 determines whether information has been received (e.g., by a polling operation) which indicates that an SLA has been aborted (e.g., because the user has expressly terminated the application, or a processing error has been encountered, etc.). If so, in action 1004, the monitoring module 124 records and passes an expiration event to the resource assignment module 122.

In action 1006, the monitoring module 124 determines whether a link (or other physical feature of the physical communication network 110) has changed. For example, the monitoring module 124 can detect that one or more links are no longer operable. Or the capacity (or other characteristics) of a link may have changed, yet the link remains operable. If so, in action 1008, the monitoring module records and passes on a network change event to the resource assignment module 122.

In action 1010, the monitoring module 124 determines whether information has been received which indicates that an SLA has been completed (e.g., because the processing task defined by the application has been completed). If so, in action 1012, the monitoring module records and passes on an expiration event to the resource assignment module 122.

Finally, FIG. 11 sets forth illustrative electrical data processing functionality 1100 that can be used to implement any aspect of the functions described above. With reference to FIG. 1, for instance, the type of processing functionality 1100 shown in FIG. 11 can be used to implement any aspect of the NRM system 102. Further, the type of processing functionality 1100 shown in FIG. 11 can be used to implement any computing machine (e.g., server) in the physical communication network 110. In one case, the processing functionality 1100 may correspond to any type of computing device that includes one or more processing devices.

The processing functionality 1100 can include volatile and non-volatile memory, such as RAM 1102 and ROM 1104, as well as one or more processing devices 1106. The processing functionality 1100 also optionally includes various media devices 1108, such as a hard disk module, an optical disk module, and so forth. The processing functionality 1100 can perform various operations identified above when the processing device(s) 1106 executes instructions that are maintained by memory (e.g., RAM 1102, ROM 1104, or elsewhere). More generally, instructions and other information can be stored on any computer readable medium 1110, including, but not limited to, static memory storage devices, magnetic storage devices, optical storage devices, and so on. The term computer readable medium also encompasses plural storage devices.

The processing functionality 1100 also includes an input/output module 1112 for receiving various inputs from a user (via input modules 1114), and for providing various outputs to the user (via output modules). One particular output mechanism may include a presentation module 1116 and an associated graphical user interface (GUI) 1118. The processing functionality 1100 can also include one or more network interfaces 1120 for exchanging data with other devices via one or more communication conduits 1122. One or more communication buses 1124 communicatively couple the above-described components together.

In closing, the description may have described various concepts in the context of illustrative challenges or problems. This manner of explication does not constitute an admission that others have appreciated and/or articulated the challenges or problems in the manner specified herein.

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for allocating network resources to an application by a network resource management system, comprising:
receiving a service level agreement (SLA) that specifies network resources that are requested by the application, to define requested network resources;
receiving network topology information regarding features of a physical communication network, and based thereon, defining available network capacity for use by plural applications as a pool of virtual network resources;
allocating, if deemed feasible by the network resource management system, a portion of the available network capacity to the application based on the SLA and the network topology information, to define an SLA assignment;
monitoring events pertaining to execution of the application on the physical communication network; and
modifying the SLA assignment in response said monitoring, if least one event is determined by the network resource management system to warrant said modifying,
the application being associated with two or more application modules, a set of communication relations representing communication paths among the application modules, and
the SLA specifying the requested network resources by identifying a communication request for each communication relation.

2. The computer-implemented method of claim 1, wherein the application is an application for execution by a data center, and wherein the physical communication network is provided by the data center.

3. The computer-implemented method of claim 1, wherein each communication request identifies one or more of:
an amount of bandwidth that is requested for the communication relation;
a latency-related performance of the communication relation;
a quality of service performance of the communication relation;
a conditional or relational constraint that pertains to the use of the communication relation;
at least one timing constraint that pertains to use of the communication relation; or
a type of communication handled by the communication relation.

4. The computer-implemented method of claim 1, wherein the SLA is expressed as a text-bearing file that identifies the application modules associated with the application in textual form.

5. The computer-implemented method of claim 1, wherein the SLA is expressed as a graphics-bearing file that identifies the application modules associated with the application in graphical form.

6. A computer readable medium for storing computer readable instructions, the computer readable instructions providing a network resource management system when executed by one or more processing devices, the computer readable instructions comprising:
resource assignment logic configured to assign portions of available network capacity to two or more applications, the available network capacity being treated as a pool of virtual network resources that map to an underlying physical communication network,
at least one application being associated with two or more application modules, a set of communication relations representing communication paths among the application modules,
the resource assignment logic being configured to assign portions of available network capacity by mapping communication relations associated with each application to the physical communication network.

7. The computer readable medium of claim 6, wherein the applications are executed by a data center, and wherein the physical communication network is provided by the data center.

8. The computer readable medium of claim 6, further comprising service level agreement interface logic configured to receive service level agreements (SLAs) associated with the applications, each SLA specifying network resources that are requested by a corresponding application, to define requested network resources for that application.

9. The computer readable medium of claim 8, further comprising network topology interface logic configured to receive network topology information, the network topology information identifying features of the physical communication network, wherein said resource assignment logic is configured to allocate portions of available network capacity based on the SLAs and the network topology information.

10. The computer readable medium of claim 9, wherein said resource assignment logic is configured to:
provision a new portion of available network capacity upon receiving a new SLA;
modify a previously assigned portion of available network capacity upon a change in the physical communication network; and
release a previously assigned portion of available network capacity upon an expiration of a previously processed SLA.

11. The computer readable medium of claim 10, further comprising monitoring logic configured to monitor events pertaining to the execution of the applications.

12. The computer readable medium of claim 11, wherein said monitoring logic is configured to:
generate an SLA expiration event upon detecting that a previously processed SLA has been aborted or completed; and
generate a network topology change event upon detecting that a feature of the physical communication network has changed.

13. The computer readable medium of claim 6, wherein the resource assignment logic is configured to treat individual links of the physical communication network as virtual resources that can be shared by two or more applications.

14. A network resource management system, implemented by electrical processing functionality, for allocating network resources to an application for execution by a data center, comprising:
a service level agreement interface module configured to receive a service level agreement (SLA), the SLA specifying network resources that are requested by the application, to define requested network resources;
a network topology interface module configured to receive network topology information, the network topology information identifying features of a physical communication network provided by the data center, and based thereon, define available network capacity for use by plural applications as a pool of virtual resources;
a resource assignment module configured to allocate, if deemed feasible, a portion of the available network capacity to the application based on the SLA and the network topology information, to define an SLA assignment; and
a monitoring module configured to monitor events pertaining to the execution of the application,
the resource assignment module being configured to modify the SLA assignment in response any monitored event that is determined to warrant reallocation of network resources.

15. The network resource management system of claim 14, wherein the service level agreement interface module is configured to receive a file that specifies components of the application, the components comprising two or more application modules and a set of communication relations that provide communication paths among the application modules.

16. The network resource management system of claim 15, wherein the file is a text-bearing file that identifies application modules associated with the application in textual form.

17. The network resource management system of claim 15, wherein the file is a graphics-bearing file that identifies application modules associated with the application in graphical form.

18. The network resource management system of claim 15, wherein the file specifies the requested network resources by identifying a communication request for each communication relation, wherein each communication request identifies one or more of:
an amount of bandwidth that is requested for the communication relation;
a latency-related performance of the communication relation;
a quality of service performance of the communication relation;
a conditional or relational constraint that pertains to the use of the communication relation;
at least one timing constraint that pertains to use of the communication relation; or
a type of communication handled by the communication relation.

19. The network resource management system of claim 14, wherein the physical communication network is a direct network, and wherein the resource assignment module is configured to dynamically perform on-demand path set-up based on the application SLA.

20. The network resource management system of claim 14, wherein the physical communication network utilizes IP routing with Differentiated Service functionality, and wherein the resource assignment module is configured to dynamically set up DiffServ mappings on routing elements within the physical communication network based on the application SLA.
